(19) United States
(12) Patent Application Publication
(10) Pub. No.: US 2026/0110538 A1
(43) Pub. Date: Apr. 23, 2026

(54) GYROSCOPE FORCE BALANCE

(71) Applicant: Analog Devices, Inc., Wilmington, MA (US)

(72) Inventor: Jiefeng Yan, Andover, MA (US)

(21) Appl. No.: 18/919,226

(22) Filed: Oct. 17, 2024

(51) Int. Cl. G01C 19/5776; G01C 19/00

(52) U.S. Cl. CPC G01C 19/5776; G01C 19/005

(57) ABSTRACT

In an example, a gyroscopic driver circuit can be configured to be coupled to a gyroscopic structure which can include a proof mass. The gyroscopic driver circuit can include an in-phase leg, which can be configured to carry the in-phase signal generated in the second primary mode of the gyroscopic structure. The gyroscopic driver circuit can also include a quadrature-phase leg, which can be configured to carry a quadrature-phase signal generated in the second primary mode of the gyroscopic structure, where the quadrature-phase signal can be in quadrature with the in-phase signal. The gyroscopic driver circuit can also include quadrature feedback circuitry, which can be configured to generate a quadrature feedback signal, where the quadrature feedback signal can include a representation of the signal on the quadrature-phase leg and a representation of the signal on the in-phase leg.

### TECHNICAL FIELD

The present disclosure relates to gyroscopic sensors, and more particularly, but not by way of limitation, to the signal chain of a gyroscopic driver circuit.

### BACKGROUND

Gyroscopic sensors can be used to sense a rotation rate about an axis. The sensed rotation rate can be used to determine an angular velocity, an angular acceleration, or both. Gyroscopic sensors can be used in handheld electronics (e.g., smartphones), vehicles, or aerospace applications.

A gyroscopic sensor can be implemented at least in part in a micro-electro-mechanical system (MEMS), which can include one or more mechanical components that are integral to a circuit chip. For example, a proof mass in a gyroscopic sensor can be manufactured at least in part using processes similar to integrated circuit production (e.g., photolithography, etching, deposition).

### SUMMARY

In an example, a gyroscopic driver circuit can be configured to be coupled to a gyroscopic structure which can include a proof mass. The proof mass can be configured to vibrate in a first primary mode, a second primary mode, or both. In use, the first primary mode can be driven into resonance. In use, an in-phase signal can be induced in the second primary mode, such as in response to a rotation of the gyroscopic structure. The gyroscopic driver circuit can include an in-phase leg, which can be configured to carry the in-phase signal generated in the second primary mode of the gyroscopic structure. The gyroscopic driver circuit can also include a quadrature-phase leg, which can be configured to carry a quadrature-phase signal generated in the second primary mode of the gyroscopic structure, where the quadrature-phase signal can be in quadrature with the in-phase signal. The gyroscopic driver circuit can also include quadrature feedback circuitry, which can be configured to generate a quadrature feedback signal, where the quadrature feedback signal can include a representation of the signal on the quadrature-phase leg and a representation of the signal on the in-phase leg.

In an example, a method for operating a gyroscopic driver circuit, the gyroscopic driver circuit can be configured to interface with a gyroscopic structure including a proof mass. The method can include forcing the proof mass using a quadrature feedback signal that can be in quadrature with an in-phase signal of the gyroscopic driver circuit. The quadrature feedback signal can include a representation of a quadrature-phase signal and a representation of the in-phase signal.

In an example, a gyroscopic driver circuit can be configured to be coupled to a gyroscopic structure including a proof mass. The proof mass can be configured to vibrate in a first primary mode, a second primary mode, or both. In use, the first primary mode can be driven into resonance. In use, an in-phase signal can be induced in the second primary mode, such as in response to a rotation of the gyroscopic structure. The gyroscopic driver circuit can include an in-phase leg, which can be configured to carry the in-phase signal generated in the second primary mode of the gyroscopic structure. The gyroscopic driver circuit can also include a quadrature-phase leg, which can be configured to carry a quadrature-phase signal generated in the second primary mode of the gyroscopic structure, where the quadrature-phase signal can be in quadrature with the in-phase signal. The gyroscopic driver circuit can also include in-phase feedback circuitry, which can be configured to generate an in-phase feedback signal, where the in-phase feedback signal can include a representation of the signal on the in-phase leg and a representation of the signal on the quadrature-phase leg.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 shows an example of portions of a block diagram of a gyroscopic sensor system.

FIG. 2 shows an example of portions of a control block diagram of a gyroscopic driver circuit.

FIG. 3 shows an example of portions of a control block diagram of a gyroscopic driver circuit.

FIG. 4 shows an example of portions of a control block diagram of a gyroscopic driver circuit.

FIG. 5 shows an example of portions of a control block diagram of a gyroscopic driver circuit.

FIG. 6 shows an example of portions of a method for operating a gyroscopic driver circuit.

FIG. 7 is a block diagram of an example of portions of a machine upon which one or more portions of the present disclosure may be implemented.

### DETAILED DESCRIPTION

A gyroscopic driver circuit can be configured to include or interface with a gyroscopic structure to generate an output signal indicative of a rate or rotation of the gyroscopic structure, such as about a specified gyroscopic axis. The gyroscopic driver circuits can be configured to have a specified accuracy and/or precision, such as can be affected by a noise level within the gyroscopic driver circuit. The gyroscopic driver circuit can be configured to detect rotation across a specified range of frequencies (e.g., the measurement bandwidth).

In an example the stability of the gyroscopic driver circuit can be an issue. For example, the gyroscopic driver circuit can experience oscillation and/or other instabilities under one or more conditions. The present inventor has recognized, among other things, that providing a feedback signal from a quadrature-phase leg to be combined with the quadrature input signal can alter a property of the system, which can include increasing a stability of the system. Additionally, it can be beneficial to include a representation of the in-phase signal in addition to the representation of the quadrature-phase signal in the feedback.

The present inventor has recognized, among other things, that it can be desirable to increase a measurement bandwidth of the gyroscopic driver circuit. An in-phase feedback signal from an in-phase leg can be provided to be combined with the in-phase input signal, which can alter (e.g., increase) a measurement bandwidth of the gyroscopic driver circuit. For example, the in-phase feedback signal can reduce a motion of the proof mass in the sense mode, which can allow for an increase in measurement bandwidth. The in-phase feedback signal can include a representation of the signal on the quadrature-phase leg in addition to the representation of a signal on the in-phase leg.

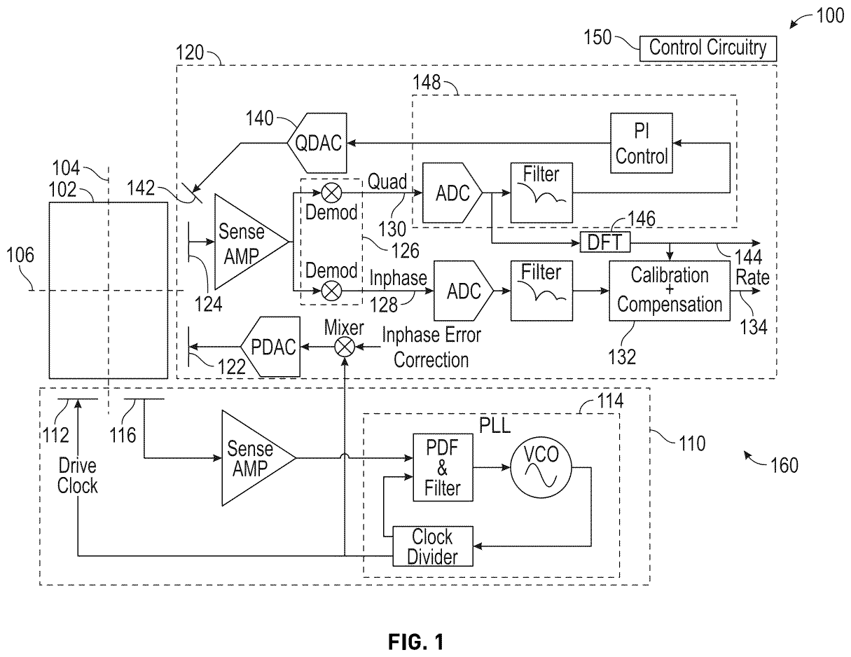

FIG. 1 shows an example of portions of a block diagram of a gyroscopic sensor system 100. FIG. 1 shows that the gyroscopic sensor system 100 can include a gyroscopic structure 102, resonator axis components 110, sense axis components 120, and control circuitry 150.

The gyroscopic structure 102 can include a proof mass. The proof mass can include one or more materials. The proof mass can take any form. In an example, the proof mass can include a block of silicon. The proof mass can be configured to move in one or more directions, which can include being connected to a substrate (e.g., the substrate of a MEMS integrated circuit chip or package substrate) via one or more mechanical connections. The mechanical connections can provide a degree of motion to the proof mass, and can provide a restoring force (e.g., a spring force) when the proof mass is displaced from a neutral position.

The proof mass can be configured to vibrate in one or more modes, which can include a first primary mode and a second primary mode. In the example of FIG. 1, the first primary mode and the second primary mode can be primary modes of a proof mass along orthogonal axes. However, the first primary mode and the second primary mode can take any form. For example, one or more of the first primary mode and the second primary mode can be modes of vibration of a disc.

The first primary mode can be along the resonator axis 104. The first primary mode can be driven into resonance, such as by the resonator axis components 110. For example, the resonator axis components 110 can provide a signal that causes the proof mass to oscillate along the resonator axis 104 at a frequency generally matching the frequency of the first primary mode.

The second primary mode can be along the sense axis 106. A signal in the second primary mode can be induced in response to a rotation of the gyroscopic sensor system 100. This signal can be called the in-phase signal. For example, when the gyroscopic sensor system 100 is rotated, the gyroscopic structure 102 can rotate along with the gyroscopic sensor system 100. The substrate around the proof mass can rotate, which can cause a portion of the signal in the first primary mode (e.g., the resonator axis 104) to couple into the second primary mode (e.g., the sense axis 106). A magnitude of the signal in the second primary mode can be indicative of a rate of rotation of the gyroscopic sensor system 100.

The resonator axis components 110 can be configured to drive the proof mass into resonance, which can include resonance in the first primary mode. The resonator axis components 110 can include a resonator electrode 112, phase locked loop circuitry 114, and a resonator sense circuit 116. The resonator electrode 112 can be configured to apply a force (e.g., an electrostatic force, such as due to an electrical signal applied to the resonator electrode 112) to the proof mass, such as along the resonator axis 104. The resonator electrode 112 can receive an electrical signal (e.g., voltage, current) and apply a force to the proof mass based on the received electrical signal, such as through one or more of electrical interaction (e.g., generating an electric field to affect the proof mass), magnetic interaction (e.g., generating a magnetic field to affect the proof mass) or electromagnetic interaction (e.g., generating an electromagnetic signal to affect the proof mass).

The resonator sense circuit 116 can be configured to generate a signal indicative of a position of the proof mass, a motion of the proof mass, or both, such as along the resonator axis 104. The resonator sense circuit 116 can include a capacitive sensor.

The phase locked loop circuitry 114 can be configured to provide a signal to the resonator electrode 112 to drive the proof mass into resonance, which can include using a feedback signal from the resonator sense circuit 116.

The sense axis components 120 can include an in-phase electrode 122, a sense circuit 124, demodulation circuitry 126, gyroscopic analysis circuitry 132, an adder 138, a quadrature DAC 140, and a quadrature force circuit 142. The in-phase electrode 122 can be configured similarly to the resonator electrode 112, or can differ in one or more ways. The in-phase electrode 122 can be configured to apply a force to the proof mass, which can include a force along the sense axis 106. The in-phase electrode 122 can be used to correct or adjust for an error of the gyroscopic sensor system 100, such as an in-phase error.

The sense circuit 124 can be configured similarly to the resonator sense circuit 116, or can differ in one or more ways. The sense circuit 124 can be configured to generate a signal indicative of a position of the proof mass, a motion of the proof mass, or both, such as along the sense axis 106. The sense circuit 124 can be configured to measure motion of the proof mass in the second primary mode.

The demodulation circuitry 126 can demodulate a signal generated by the sense circuit 124 into an in-phase signal on the in-phase signal node 128 and a quadrature signal on the Quadrature signal node 130. The in-phase signal can be induced at least in part from cross coupling with the first primary mode during rotation of the gyroscopic sensor system 100. The phase of the in-phase signal can be specified, measured, or calibrated. For example, the phase of the in-phase signal can match a phase of the resonant signal in the first primary mode.

The gyroscopic analysis circuitry 132 can be configured to use the in-phase signal to determine a rate of rotation of the proof mass about a gyroscopic axis (e.g., the axis about which the gyroscopic sensor system 100 measures rotation). The gyroscopic analysis circuitry 132 can receive a signal indicative of the in-phase signal (e.g., a filtered version of the in-phase signal), a signal indicative of the quadrature signal (e.g., a filtered version of the quadrature signal), or both. The gyroscopic analysis circuitry 132 can generate a signal indicative of the rotation rate of the gyroscopic sensor system 100 on the output signal node 134.

The determined rotation rate can be affected by a sensitivity of the gyroscopic sensor system 100, which can include being proportional to the sensitivity of the gyroscopic sensor system 100. The proportionality of the sensitivity of the system can be shown in equation 1.

$$Sensitivity ∝ {ω}_{res} * {x}_{res} * \frac{1}{Δ f} * {T}_{cor} \qquad Equation 1$$

In equation 1, ωᵣₑₛ is the frequency of the first primary mode, which can be expressed in units of radians per second, xᵣₑₛ is the displacement of the proof mass, such as in the first primary mode (e.g., along the resonator axis 104), which can be expressed in units of meters, Δf is the frequency difference between the first primary mode and the second primary mode, which can be expressed in units of radians per second, and T_{cor} is the Coriolis sense transduction of the gyroscopic structure 102, which can be expressed in units of farads per meter. In an example, ωᵣₑₛ can be specified or measured. In an example, xᵣₑₛ can be specified or measured (e.g., using the resonator sense circuit 116). In an example, Δf can be specified or measured. In an example, T_{cor} can be specified or measured.

The quadrature digital-to-analog converter (DAC) 140 can convert the output of the quadrature error correction circuit 148 to analog format. In an example where the quadrature signal is analog, the quadrature DAC 140 can be omitted.

The quadrature force circuit 142 can be configured similarly to one or more of the resonator electrode 112 or the in-phase electrode 122, or can differ in one or more ways. The quadrature force circuit 142 can be configured to apply a force to the proof mass, such as along the sense axis 106. The quadrature force circuit 142 can be configured to apply a force to the proof mass along the sense axis 106 that is configured to produce a response in the proof mass (e.g., a quadrature response) that is in quadrature with the in-phase signal (e.g., the signal on the in-phase signal node 128). The quadrature force circuit can be configured to force the second primary mode of the proof mass.

The control circuitry 150 can be configured to control one or more portions of the gyroscopic sensor system 100. In an example, one or more portions of the resonator axis components 110 (e.g., the phase locked loop circuitry 114), the sense axis components 120 (e.g., the gyroscopic analysis circuitry 132), or both, can include or be included in the control circuitry 150.

The sense axis components 120 can include a quadrature error correction circuit 148. The quadrature error correction circuit 148 can be configured to force the quadrature force circuit 142 using a quadrature error correction signal. The quadrature error correction signal can be configured to correct for a quadrature error of the gyroscopic sensor system 100. The quadrature error in the gyroscopic sensor system 100 can arise at least in part from a cross-axis stiffness of the gyroscopic structure 102 (e.g., a portion of the first primary mode couples to the second primary mode even when the gyroscopic sensor system 100 is not rotating). The quadrature error correction signal can be or include a DC signal. Because of the motion of the proof mass, a DC signal on the quadrature force circuit 142 can have a periodic effect (e.g., AC effect) on the proof mass. For example, the effect of the DC signal can be greater when the proof mass is closer and/or lesser when the proof mass is farther away. This can result in the force on the proof mass caused by a DC signal on the quadrature force circuit 142 having an AC effect at approximately the frequency of the first primary mode, the second primary mode, or a composite frequency.

The gyroscopic driver circuit 160 can include or be included in one or more portions of the gyroscopic sensor system 100. The gyroscopic driver circuit 160 can include one or more portions of one or more of the resonator axis components 110, the sense axis components 120, or the control circuitry 150. In an example, the gyroscopic driver circuit 160 can include the gyroscopic structure 102.

The gyroscopic driver circuit 160 can be configured to be coupled to a gyroscopic structure 102, such as including a proof mass. The proof mass can be configured to vibrate in a first primary mode, a second primary mode, or both. In use the first primary mode can be driven into resonance. In use, an in-phase signal can be induced in the second primary mode in response to a rotation of the gyroscopic structure.

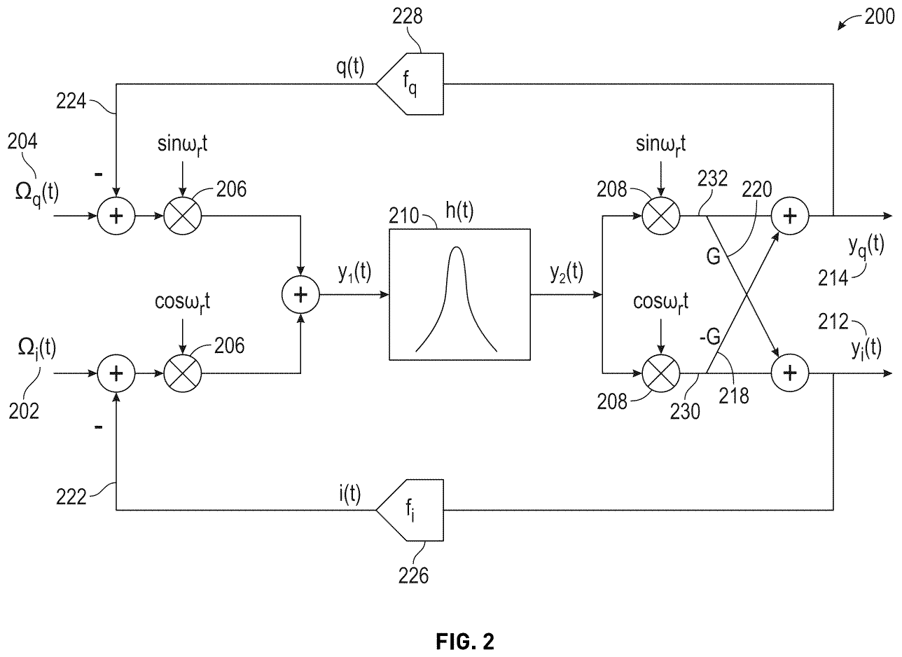

FIG. 2 shows an example of portions of a control block diagram 200 of a gyroscopic driver circuit, such as the gyroscopic driver circuit 160. The control block diagram 200 can represent one or more functions of the gyroscopic driver circuit 160. The control block diagram 200 shows that the gyroscopic driver circuit 160 can include an in-phase input signal 202, a quadrature input signal 204, a transfer function 210, an in-phase leg 230, a quadrature-phase leg 232, quadrature output signal 214, and an in-phase output signal 212.

The in-phase input signal 202 can be and/or represent the in-phase input to the gyroscopic structure 102, which can include the input rotation rate. For example, the in-phase input signal 202 can be the rate of rotation of the gyroscopic structure 102. In an example, the in-phase input signal 202 can also include an in-phase error signal, such as can be due at least in part to a construction of the gyroscopic structure 102.

The quadrature input signal 204 can be and/or represent the quadrature input to the gyroscopic structure 102, which can include a quadrature error signal. The quadrature error signal can be due at least in part to a construction of the gyroscopic structure 102 (e.g., a cross-axial stiffness).

One or more of the in-phase input signal 202 or the quadrature input signal 204 can be modulated, such as by the modulator 206 (e.g., modulated by the gyroscopic structure 102, such as alternatively or in addition to modulation circuitry). This modulation step can introduce and/or determine a phase difference between the in-phase input signal 202 and the quadrature input signal 204, which can include a 90 degree phase difference (e.g., the quadrature input signal 204 can be in quadrature with the in-phase input signal 202).

The transfer function 210 can be and/or represent the transfer function of one or more portions of a gyroscopic structure, such as the gyroscopic structure 102. The transfer function 210 can determine the output y₂ (t) of the gyroscopic structure 102 based on a given input y₁(t) to the gyroscopic structure 102. One or more of the in-phase input signal 202 or the quadrature input signal 204 can be modulated (e.g., modulated by the gyroscopic structure) and/or combined before being input to the transfer function 210.

The demodulator 208 can demodulate the output from the transfer function 210. The demodulator 208 can be configured to receive a representation of a motion of the proof mass, such as a motion in the second primary mode, and can be configured to generate one or more of the in-phase signal and the quadrature-phase signal. The demodulator 208 can include or be included in one or more portions of the demodulation circuitry 126. The demodulator 208 can generate a signal on the in-phase leg 230, a signal on the quadrature-phase leg 232, or both, such as by projecting the output signal from the transfer function 210 onto one or more functions (e.g., projecting the output signal onto a cosine function to determine the in-phase signal, projecting the output signal onto a sine function to determine the quadrature phase signal).

The in-phase leg 230 can be configured to carry the in-phase signal which can be generated in the second primary mode of the gyroscopic structure 102, such as can include the in-phase signal node 128.

The quadrature-phase leg can be configured to carry a quadrature-phase signal which can be generated in the second primary mode of the gyroscopic structure 102, such as can include the quadrature signal node 130. The quadrature-phase signal can be in quadrature with the in-phase signal.

The in-phase output signal 212 can be and/or represent the in-phase output of the gyroscopic structure, which can include a representation of the rotation rate of the gyroscopic structure 102 (e.g., the signal on the output signal node 134). The in-phase output signal 212 can include a representation of the signal on the in-phase leg 230.

The quadrature output signal 214 can be and/or represent the quadrature phase output of the gyroscopic structure, which can include the quadrature error signal. (e.g., the signal on the quadrature response node 144). The quadrature output signal 214 can include a representation of the signal on the quadrature-phase leg 232.

In an example, some components of the gyroscopic driver circuit 160 can represent electrical signals (e.g., a voltage and/or a current), such as can include one or more of the in-phase output signal 212, and the quadrature output signal 214, and some components can represent non-electrical signals (e.g., a rotation rate, a physical response of a physical system to a stimulus, an error introduced in a system), such as can include one or more of the in-phase input signal 202, the quadrature input signal 204, the modulator 206, or the transfer function 210.

The gyroscopic driver circuit 160 can also include quadrature feedback circuitry 228, which can be configured to generate a quadrature feedback signal on the quadrature feedback signal node 224. The quadrature feedback circuitry 228 can be configured to provide the quadrature feedback signal to be combined with the quadrature input signal 204, such as before modulation in the modulator 206. The quadrature feedback circuitry 228 can provide a portion of the quadrature output signal 214 as a feedback signal, can provide a portion of the signal on the quadrature-phase leg 232 alone or combined with one or more other signals, or both. The quadrature feedback circuitry 228 can include a gain factor (e.g., including gain or attenuation). For example, the quadrature feedback circuitry 228 can include a gain circuit through which the quadrature feedback signal is passed before being applied to the gyroscopic structure 102. The quadrature feedback circuitry 228 (e.g., the gain circuit) can include one or more of proportional gain, integrating gain, or differentiating gain. In an example, the quadrature feedback signal can include a representation of the signal on the quadrature-phase leg 232 and a representation of the signal on the in-phase leg 230.

The quadrature feedback circuitry 228 can be configured to generate the quadrature feedback signal so as to adjust a quadrature error of the gyroscopic structure 102. For example, a quadrature error can be introduced into the gyroscopic structure 102, such as due to a cross-axial stiffness of the gyroscopic structure 102. This quadrature error can affect a signal of the gyroscopic sensor system 100, which can affect an accuracy of the gyroscopic sensor system 100. For example, the quadrature error can affect the signal on the output signal node 134. The quadrature error can be adjusted (e.g., reduced) by the signal on the quadrature feedback signal node 224. The signal on the quadrature feedback signal node 224 can represent a signal applied to the quadrature force circuit 142. For example, the quadrature force circuit can be configured to receive the quadrature feedback signal and force the second primary mode of the proof mass in quadrature with the in-phase signal. The quadrature feedback signal can be implemented in the analog domain, the digital domain, or both. For example, the quadrature feedback signal can be derived from a location on the quadrature-phase leg 232 before digitization occurs. The quadrature feedback circuitry 228 can include analog circuitry, such as alternatively or in addition to digital circuitry.

The gyroscopic driver circuit 160 can also include one or more of an in-phase crossover circuit 218 or a quadrature crossover circuit 220. The in-phase crossover circuit 218 can be configured to add a representation of the in-phase signal to the quadrature-phase leg 232. The quadrature crossover circuit 220 can be configured to add a representation of the quadrature-phase signal to the in-phase leg 230. In an example, the quadrature feedback circuitry 228 can be configured to generate the quadrature feedback signal from the quadrature-phase leg 232 at a location after the in-phase crossover circuit, such as can be shown in FIG. 2.

The in-phase crossover circuit 218 can include one or more of a polarity or gain factor. For example, the signal on the in-phase leg 230 can be inverted, multiplied by a gain factor (e.g., including attenuation), or both before being added into the quadrature-phase leg 232. The gain factor can be specified, tuned, or calibrated, such as to achieve a specified function of the gyroscopic driver circuit 160. For example, the gain factor can be adjusted until the gyroscopic driver circuit 160 reaches a specified degree of stability, instability, or both. The gyroscopic driver circuit 160 can produce oscillation (e.g., instability) under certain conditions without the in-phase crossover circuit 218, and the gain of the in-phase crossover circuit 218 can be increased until the system stability reaches a specified level under these same conditions (e.g., until oscillations stop or substantially stop). In an example, the gain can be increased until the system becomes unstable, or nearly unstable. For example, the gain can be increased until the system becomes unstable, and then reduced to the largest value at which the system was stable.

The quadrature crossover circuit 220 can include one or more of a polarity or gain factor. For example, the signal on the in-phase leg 230 can be multiplied by a gain factor (e.g., including attenuation) before being added into the in-phase leg. The gain factor can be specified, tuned, or calibrated, such as to achieve a specified function of the gyroscopic driver circuit 160. For example, the gain factor can be adjusted until the gyroscopic driver circuit 160 reaches a specified degree of stability, instability, or both. The gyroscopic driver circuit 160 can produce oscillation (e.g., instability) under certain conditions without the quadrature crossover circuit 220, and the gain of the quadrature crossover circuit 220 can be increased until the system stability reaches a specified level under these same conditions (e.g., until oscillations stop or substantially stop). In an example, the gain can be increased until the system becomes unstable, or nearly unstable. For example, the gain can be increased until the system becomes unstable, and then reduced to the largest value at which the system was stable.

The gyroscopic driver circuit 160 can also include in-phase feedback circuitry 226, which can be configured to generate an in-phase feedback signal on the in-phase feedback signal node 222. The in-phase feedback circuitry 226 can be configured to provide the in-phase feedback signal to be combined with the in-phase input signal 202, such as before modulation in the modulator 206. The in-phase feedback circuitry 226 can provide a portion of the in-phase output signal 212 as a feedback signal, can provide a portion of the signal on the in-phase leg 230 alone or in combination with one or more other signals, or both. The in-phase feedback circuitry 226 can include a gain factor (e.g., including gain or attenuation). The in-phase feedback circuitry 226 can include one or more of proportional gain, integrating gain, or differentiating gain. In an example, the in-phase feedback signal can include a representation of the signal on the in-phase leg 230 and a representation of the signal on the quadrature-phase leg 232. The signal on the in-phase feedback signal node 222 can represent a portion of the signal applied to the in-phase electrode 122. The in-phase feedback signal can be implemented in the analog domain, the digital domain, or both. For example, the in-phase feedback signal can be derived from a location on the in-phase leg 230 before digitization occurs. The in-phase feedback circuitry 226 can include analog circuitry, such as alternatively or in addition to digital circuitry. In an example, the in-phase feedback circuitry 226 can be configured to generate the in-phase feedback signal at a location after the quadrature crossover circuit, such as can be shown in FIG. 2.

The in-phase feedback circuitry can be configured to generate the in-phase feedback signal to adjust one or more of an in-phase error of the gyroscopic driver circuit 160 or reduce a motion of the proof mass in the second primary mode. For example, the in-phase feedback signal can be configured to reduce an in-phase error of the gyroscopic driver circuit 160. This can affect an accuracy and/or precision of the gyroscopic driver circuit 160, which can include increasing the accuracy and/or precision of the gyroscopic driver circuit 160.

Reducing a motion of the proof mass in the second primary mode can include reducing an amplitude of the in-phase signal. For example, the in-phase feedback circuitry 226 can be configured and/or tuned such that the in-phase feedback signal counteracts the in-phase input signal 202 (e.g., the signal generated by the rotation of the gyroscopic structure). This can reduce an amplitude of the in-phase output signal 212 generated by a specified in-phase input signal 202.

In an example, the in-phase feedback circuitry 226 can be configured to generate the in-phase feedback signal such as to limit a motion of the proof mass in the second primary mode to substantially zero (e.g., zero, an amplitude representing a small fraction (e.g., 1/20, 1/50, 1/100) of the motion of the proof mass without the in-phase feedback circuitry 226). In this example, the in-phase output signal 212 can also be substantially zero, such as because the in-phase output signal 212 corresponds to the motion of the proof mass in the second primary mode.

In an example, the in-phase feedback signal can be used to determine a rate of rotation of the proof mass about a gyroscopic axis, such as using the gyroscopic analysis circuitry 132. For example, the gyroscopic analysis circuitry 132 can receive a representation of the in-phase feedback signal and generate a signal representing the rate of rotation of the gyroscopic structure. This generated signal can correspond to the in-phase output signal 212 when the in-phase feedback circuitry 226 is not in use. For example, based on a parameter of the in-phase feedback signal (e.g., an amplitude, a frequency) or another parameter (e.g., an operating parameter of the in-phase feedback circuitry 226), the gyroscopic analysis circuitry 132 can determine the in-phase output signal 212 that would have been generated if the in-phase feedback signal was not combined with the in-phase input signal 202. This determined signal can then be used, such as to determine the rotation rate of the gyroscopic structure. In an example, the gyroscopic analysis circuitry 132 can use one or more signals in addition to the in-phase feedback signal, such as the signal on the in-phase leg 230.

In an example, the in-phase feedback circuitry 226 can be configured to generate the in-phase feedback signal such as to increase a bandwidth of rates of rotation that the gyroscopic driver circuit 160 can be configured to measure. For example, reducing an amplitude of the proof mass in the second primary mode can increase a measurement bandwidth of the gyroscopic sensor system 100, such as by one or more of reducing a noise generated by the motion of the proof mass or reducing a parasitic effect of the motion of the proof mass. In an example, the in-phase feedback circuitry 226 can increase a bandwidth of the gyroscopic sensor system 100 by having a faster response time than the transfer function 210. For example, the circuits in the in-phase feedback circuitry 226 may be able to react faster than the physical components of the gyroscopic structure 102.

In an example, various combinations and permutations of configuration can be used. For example, the gyroscopic driver circuit 160 can include one or more of the in-phase crossover circuit 218, the quadrature crossover circuit 220, the in-phase feedback circuitry 226, or the quadrature feedback circuitry 228, or need not include one or more of these components.

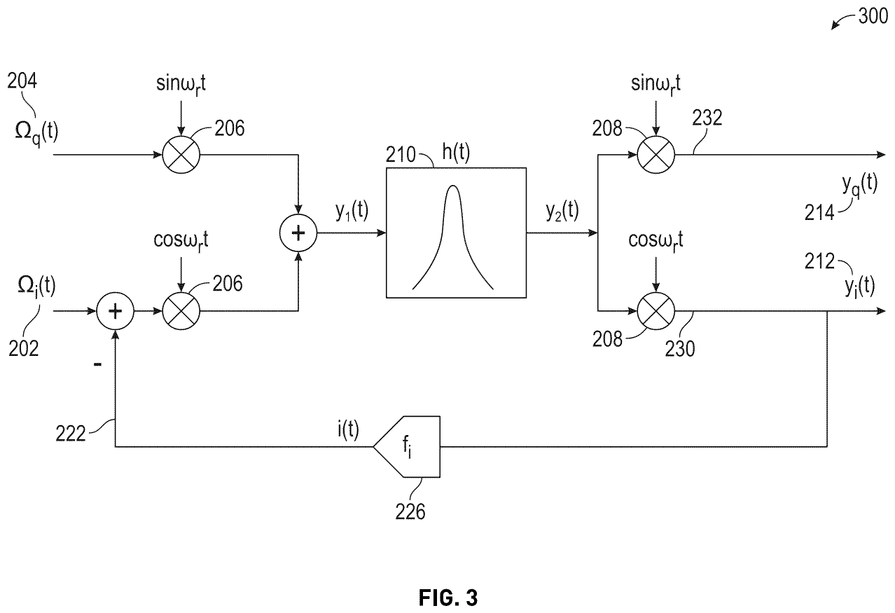

FIG. 3 shows an example of portions of a control block diagram 300 of a gyroscopic driver circuit, such as the gyroscopic driver circuit 160. In the example of control block diagram 300, there may be an in-phase feedback circuitry 226, and one or more of the in-phase crossover circuit 218, the quadrature crossover circuit 220, or the quadrature feedback circuitry 228 can be omitted. In this example, the in-phase feedback circuitry 226 can function to reduce a motion of the proof mass in the second primary mode, such as can increase a measurement bandwidth of the gyroscopic driver circuit 160. In an example, the control block diagram 300 can include a quadrature crossover circuit 220 to provide a representation of the quadrature-phase leg 232 to the in-phase leg 230, such as at a location before the in-phase feedback signal is derived.

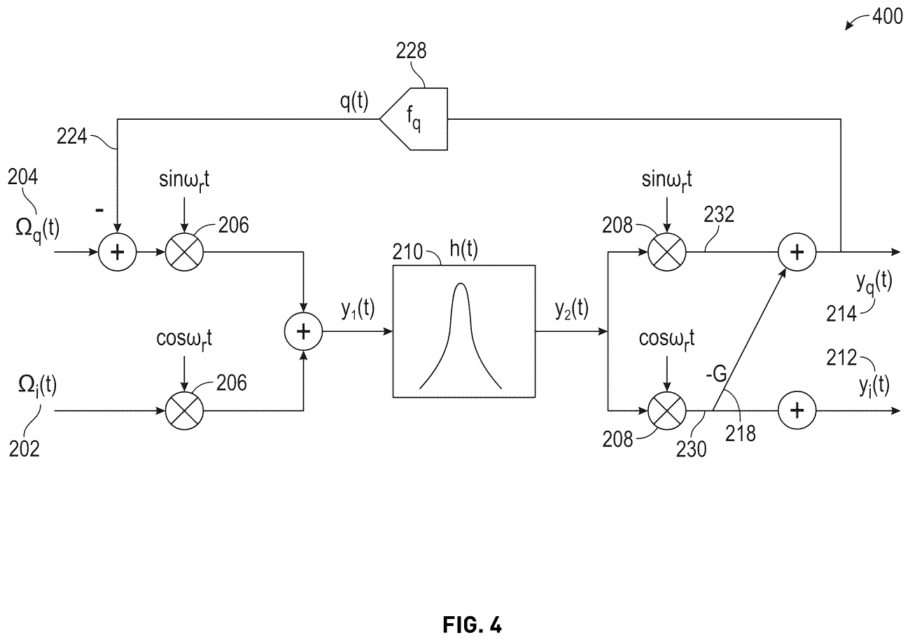

FIG. 4 shows an example of portions of a control block diagram 400 of a gyroscopic driver circuit, such as the gyroscopic driver circuit 160. In the example of control block diagram 400, there may be an in-phase crossover circuit 218 and quadrature feedback circuitry 228, and one or more of the quadrature crossover circuit 220 or the in-phase feedback circuitry 226 may be omitted. In this example, the quadrature feedback circuitry 228 can be configured to alter an accuracy or precision of the gyroscopic driver circuit 160 (e.g., increase an accuracy of the in-phase output signal 212).

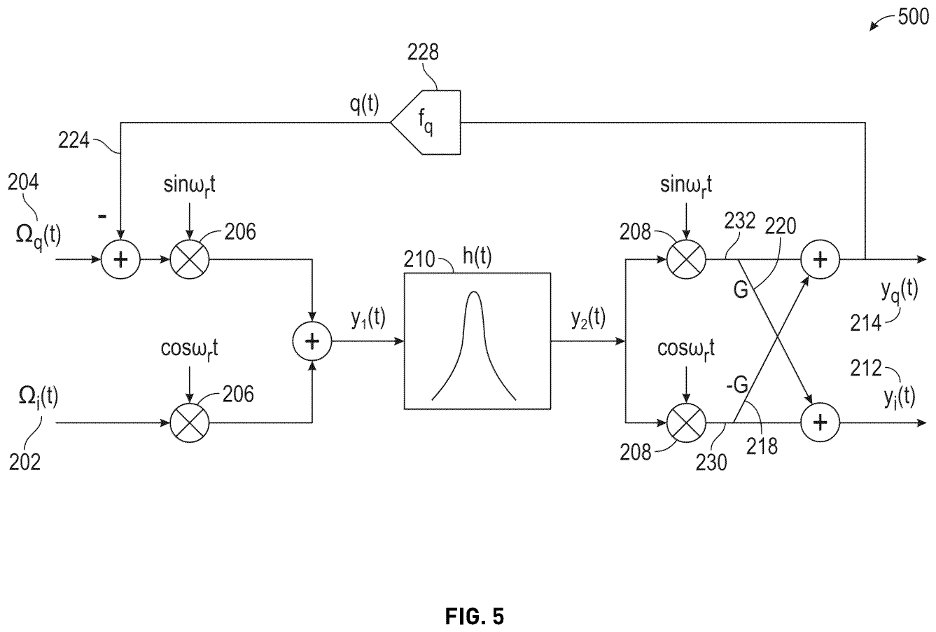

FIG. 5 shows an example of portions of a control block diagram 500 of a gyroscopic driver circuit, such as the gyroscopic driver circuit 160. In the example of control block diagram 500, there may be an in-phase crossover circuit 218, a quadrature crossover circuit 220, and quadrature feedback circuitry 228, and the in-phase feedback circuitry 226 may be omitted. In this example, the quadrature feedback circuitry 228 can be configured to alter an accuracy or precision of the gyroscopic driver circuit 160 (e.g., increase an accuracy of the in-phase output signal 212). In this example, the quadrature crossover circuit 220 can be configured to alter an accuracy or precision of the gyroscopic driver circuit 160, such as by stabilizing the signal on the in-phase leg 230.

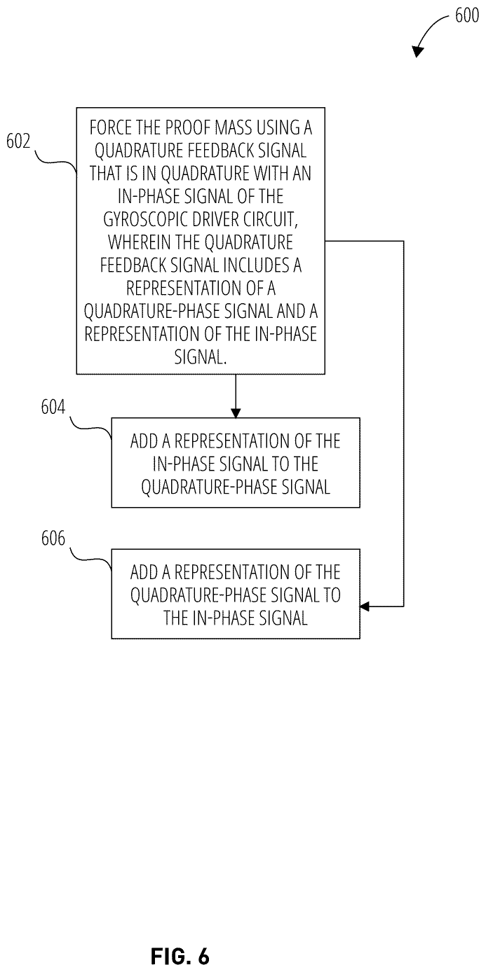

FIG. 6 shows an example of portions of a method 600 for operating a gyroscopic driver circuit, such as the gyroscopic driver circuit 160. The gyroscopic driver circuit 160 can be configured to interface with a gyroscopic structure which can include a proof mass, such as the gyroscopic structure 102.

At step 602, the proof mass can be forced using a quadrature feedback signal that can be in quadrature with an in-phase signal of the gyroscopic driver circuit, wherein the quadrature feedback signal can include a representation of a quadrature-phase signal and a representation of the in-phase signal. For example, the proof mass can be forced using the quadrature force circuit 142. The quadrature force circuit 142 can be driven by a signal generated at least in part by the quadrature feedback circuitry 228, such as can include a representation of the signal on the quadrature-phase leg 232, the in-phase leg 230 (e.g., due to the in-phase crossover circuit 218), or both.

At step 604, a representation of the in-phase signal can be added to the quadrature-phase signal. For example, the in-phase crossover circuit 218 can add a representation of the in-phase signal to the quadrature-phase signal.

At step 606, a representation of the quadrature-phase signal can be added to the in-phase signal. For example, the quadrature crossover circuit 220 can add a representation of the quadrature-phase signal to the in-phase leg.

In an example, the proof mass can be forced using an in-phase feedback signal that is in phase with the in-phase signal of the gyroscopic driver circuit, wherein the in-phase feedback signal can include a representation of the in-phase signal and a representation of the quadrature-phase signal. In an example, the in-phase feedback signal can be adjusted to limit a motion of the proof mass in a sense mode to substantially zero. The rate of rotation of the gyroscopic structure about a gyroscopic axis can be determined using the in-phase feedback signal.

The shown order of steps is not intended to be a limitation on the order in which the steps are performed. In an example, two or more steps may be performed simultaneously or at least partially concurrently.

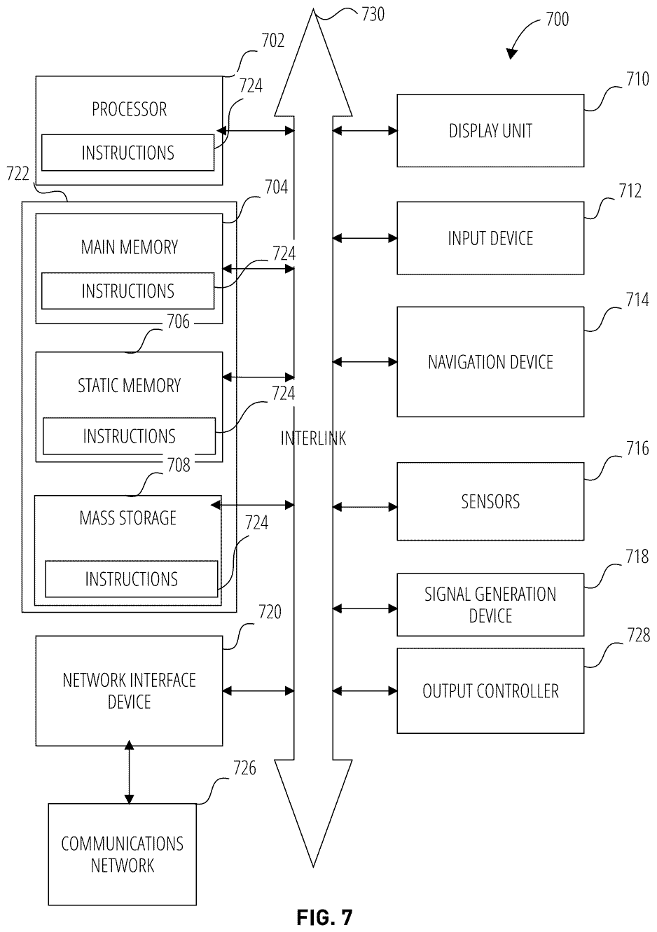

FIG. 7 illustrates a block diagram of an example machine 700 upon which any one or more of the techniques (e.g., methodologies) discussed herein may be implemented. Examples, as described herein, may include, or may operate by, logic or a number of components, or mechanisms in the machine 700. Circuitry (e.g., processing circuitry) is a collection of circuits implemented in tangible entities of the machine 700 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 700 follow.

In alternative examples, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 700 may include a hardware processor 702 (e.g., a central processing unit (CPU), a graphics processing unit (GPU), a hardware processor core, or any combination thereof), a main memory 704, a static memory (e.g., memory or storage for firmware, microcode, a basic-input-output (BIOS), and mass storage 708 (e.g., hard drives, tape drives, flash storage, or other block devices) some or all of which may communicate with each other via an interlink 730 (e.g., bus). The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a signal generation device 718 (e.g., a speaker), a network interface device 720, and one or more sensors 716, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 702, the main memory 704, the static memory 706, or the mass storage 708 may be, or include, a machine readable medium 722 on which is stored one or more sets of data structures or instructions 724 (e.g., software) embodying or utilized by any one or more of the techniques or functions described herein. The instructions 724 may also reside, completely or at least partially, within any of registers of the processor 702, the main memory 704, the static memory 706, or the mass storage 708 during execution thereof by the machine 700. In an example, one or any combination of the hardware processor 702, the main memory 704, the static memory 706, or the mass storage 708 may constitute the machine readable media 722. While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 722 may be representative of the instructions 724, such as instructions 724 themselves or a format from which the instructions 724 may be derived. This format from which the instructions 724 may be derived may include source code, encoded instructions (e.g., in compressed or encrypted form), packaged instructions (e.g., split into multiple packages), or the like. The information representative of the instructions 724 in the machine readable medium 722 may be processed by processing circuitry into the instructions to implement any of the operations discussed herein. For example, deriving the instructions 724 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 724.

In an example, the derivation of the instructions 724 may include assembly, compilation, or interpretation of the information (e.g., by the processing circuitry) to create the instructions 724 from some intermediate or preprocessed format provided by the machine readable medium 722. The information, when provided in multiple parts, may be combined, unpacked, and modified to create the instructions 724. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 724 may be further transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software. A transmission medium is a machine-readable medium.

The following, non-limiting examples, detail certain aspects of the present subject matter to solve the challenges and provide the benefits discussed herein, among others.

### Examples

Example 1 is a gyroscopic driver circuit configured to be coupled to a gyroscopic structure including a proof mass, the proof mass configured to vibrate in a first primary mode and a second primary mode, wherein in use the first primary mode is driven into resonance, wherein in use an in-phase signal is induced in the second primary mode in response to a rotation of the gyroscopic structure, the gyroscopic driver circuit comprising: an in-phase leg, configured to carry the in-phase signal generated in the second primary mode of the gyroscopic structure; a quadrature-phase leg, configured to carry a quadrature-phase signal generated in the second primary mode of the gyroscopic structure, wherein the quadrature-phase signal is in quadrature with the in-phase signal; and quadrature feedback circuitry, configured to: generate a quadrature feedback signal, wherein the quadrature feedback signal includes a representation of the signal on the quadrature-phase leg and a representation of the signal on the in-phase leg.

In Example 2, the subject matter of Example 1 optionally includes wherein the quadrature feedback circuitry is configured to generate the quadrature feedback signal so as to adjust a quadrature error of the gyroscopic structure.

In Example 3, the subject matter of any one or more of Examples 1-2 optionally include a demodulator, configured to receive a representation of a motion of the proof mass in the second primary mode and generate the in-phase signal and the quadrature-phase signal.

In Example 4, the subject matter of any one or more of Examples 1-3 optionally include an in-phase crossover circuit, configured to add a representation of the in-phase signal to the quadrature-phase leg; and a quadrature crossover circuit, configured to add a representation of the quadrature-phase signal to the in-phase leg.

In Example 5, the subject matter of Example 4 optionally includes in-phase feedback circuitry, configured to: generate an in-phase feedback signal, wherein the in-phase feedback signal includes a representation of the signal on the in-phase leg and a representation of the signal on the quadrature-phase leg.

In Example 6, the subject matter of Example 5 optionally includes wherein the in-phase feedback circuitry is configured to generate the in-phase feedback signal so as to at least one of adjust an in-phase error of the gyroscopic driver circuit or reduce a motion of the proof mass in the second primary mode.

In Example 7, the subject matter of Example 6 optionally includes wherein the in-phase feedback circuitry is configured to generate the in-phase feedback signal so as to limit a motion of the proof mass in the second primary mode to substantially zero.

In Example 8, the subject matter of Example 7 optionally includes gyroscopic analysis circuitry, configured to use the in-phase feedback signal to determine a rate of rotation of the gyroscopic structure about a gyroscopic axis.

In Example 9, the subject matter of Example 8 optionally includes wherein the in-phase feedback circuitry is configured to generate the in-phase feedback signal so as to increase a bandwidth of rates of rotation that the gyroscopic driver circuit is configured to measure.

In Example 10, the subject matter of any one or more of Examples 4-9 optionally include wherein the quadrature feedback circuitry is configured to generate the quadrature feedback signal from the quadrature-phase leg at a location after the in-phase crossover circuit.

In Example 11, the subject matter of Example 10 optionally includes a gain circuit through which the quadrature feedback signal is passed before being applied to the gyroscopic structure.

In Example 12, the subject matter of Example 11 optionally includes wherein the gain circuit includes an integrating circuit.

In Example 13, the subject matter of any one or more of Examples 1-12 optionally include the gyroscopic structure; and a quadrature force circuit, configured to receive the quadrature feedback signal and force the second primary mode of the proof mass in quadrature with the in-phase signal.

In Example 14, the subject matter of any one or more of Examples 1-13 optionally include wherein the quadrature feedback signal is implemented in an analog domain.

Example 15 is a method for operating a gyroscopic driver circuit, the gyroscopic driver circuit configured to interface with a gyroscopic structure including a proof mass, the method comprising: forcing the proof mass using a quadrature feedback signal that is in quadrature with an in-phase signal of the gyroscopic driver circuit, wherein the quadrature feedback signal includes a representation of a quadrature-phase signal and a representation of the in-phase signal.

In Example 16, the subject matter of Example 15 optionally includes adding a representation of the in-phase signal to the quadrature-phase signal; and adding a representation of the quadrature-phase signal to the in-phase signal.

In Example 17, the subject matter of any one or more of Examples 15-16 optionally include forcing the proof mass using an in-phase feedback signal that is in phase with the in-phase signal of the gyroscopic driver circuit, wherein the in-phase feedback signal includes a representation of the in-phase signal and a representation of the quadrature-phase signal.

In Example 18, the subject matter of Example 17 optionally includes adjusting the in-phase feedback signal to limit a motion of the proof mass in a sense mode to substantially zero; and determining a rate of rotation of the gyroscopic structure about a gyroscopic axis using the in-phase feedback signal.

Example 19 is a gyroscopic driver circuit configured to be coupled to a gyroscopic structure including a proof mass, the proof mass configured to vibrate in a first primary mode and a second primary mode, wherein in use the first primary mode is driven into resonance, wherein in use an in-phase signal is induced in the second primary mode in response to a rotation of the gyroscopic structure, the gyroscopic driver circuit comprising: an in-phase leg, configured to carry the in-phase signal generated in the second primary mode of the gyroscopic structure; a quadrature-phase leg, configured to carry a quadrature-phase signal generated in the second primary mode of the gyroscopic structure, wherein the quadrature-phase signal is in quadrature with the in-phase signal; and in-phase feedback circuitry, configured to: generate an in-phase feedback signal, wherein the in-phase feedback signal includes a representation of the signal on the in-phase leg and a representation of the signal on the quadrature-phase leg.

In Example 20, the subject matter of Example 19 optionally includes wherein the in-phase feedback circuitry is configured to generate the in-phase feedback signal so as to increase a measurement bandwidth of the gyroscopic structure.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the terms “or” and “and/or” are used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A gyroscopic driver circuit configured to be coupled to a gyroscopic structure including a proof mass, the proof mass configured to vibrate in a first primary mode and a second primary mode, wherein in use the first primary mode is driven into resonance, wherein in use an in-phase signal is induced in the second primary mode in response to a rotation of the gyroscopic structure, the gyroscopic driver circuit comprising:
an in-phase leg, configured to carry the in-phase signal generated in the second primary mode of the gyroscopic structure;
a quadrature-phase leg, configured to carry a quadrature-phase signal generated in the second primary mode of the gyroscopic structure, wherein the quadrature-phase signal is in quadrature with the in-phase signal; and
quadrature feedback circuitry, configured to:
generate a quadrature feedback signal, wherein the quadrature feedback signal includes a representation of the signal on the quadrature-phase leg and a representation of the signal on the in-phase leg.

2. The gyroscopic driver circuit of claim 1, wherein the quadrature feedback circuitry is configured to generate the quadrature feedback signal so as to adjust a quadrature error of the gyroscopic structure.

3. The gyroscopic driver circuit of claim 1, comprising:
a demodulator, configured to receive a representation of a motion of the proof mass in the second primary mode and generate the in-phase signal and the quadrature-phase signal.

4. The gyroscopic driver circuit of claim 1, comprising:
an in-phase crossover circuit, configured to add a representation of the in-phase signal to the quadrature-phase leg; and
a quadrature crossover circuit, configured to add a representation of the quadrature-phase signal to the in-phase leg.

5. The gyroscopic driver circuit of claim 4, comprising:
in-phase feedback circuitry, configured to:
generate an in-phase feedback signal, wherein the in-phase feedback signal includes a representation of the signal on the in-phase leg and a representation of the signal on the quadrature-phase leg.

6. The gyroscopic driver circuit of claim 5, wherein the in-phase feedback circuitry is configured to generate the in-phase feedback signal so as to at least one of adjust an in-phase error of the gyroscopic driver circuit or reduce a motion of the proof mass in the second primary mode.

7. The gyroscopic driver circuit of claim 6, wherein the in-phase feedback circuitry is configured to generate the in-phase feedback signal so as to limit a motion of the proof mass in the second primary mode to substantially zero.

8. The gyroscopic driver circuit of claim 7, comprising:
gyroscopic analysis circuitry, configured to use the in-phase feedback signal to determine a rate of rotation of the gyroscopic structure about a gyroscopic axis.

9. The gyroscopic driver circuit of claim 8, wherein the in-phase feedback circuitry is configured to generate the in-phase feedback signal so as to increase a bandwidth of rates of rotation that the gyroscopic driver circuit is configured to measure.

10. The gyroscopic driver circuit of claim 4, wherein the quadrature feedback circuitry is configured to generate the quadrature feedback signal from the quadrature-phase leg at a location after the in-phase crossover circuit.

11. The gyroscopic driver circuit of claim 10, comprising a gain circuit through which the quadrature feedback signal is passed before being applied to the gyroscopic structure.

12. The gyroscopic driver circuit of claim 11, wherein the gain circuit includes an integrating circuit.

13. The gyroscopic driver circuit of claim 1, further comprising:
the gyroscopic structure; and
a quadrature force circuit, configured to receive the quadrature feedback signal and force the second primary mode of the proof mass in quadrature with the in-phase signal.

14. The gyroscopic driver circuit of claim 1, wherein the quadrature feedback signal is implemented in an analog domain.

15. A method for operating a gyroscopic driver circuit, the gyroscopic driver circuit configured to interface with a gyroscopic structure including a proof mass, the method comprising:
forcing the proof mass using a quadrature feedback signal that is in quadrature with an in-phase signal of the gyroscopic driver circuit, wherein the quadrature feedback signal includes a representation of a quadrature-phase signal and a representation of the in-phase signal.

16. The method of claim 15, comprising:
adding a representation of the in-phase signal to the quadrature-phase signal; and
adding a representation of the quadrature-phase signal to the in-phase signal.

17. The method of claim 15, comprising:
forcing the proof mass using an in-phase feedback signal that is in phase with the in-phase signal of the gyroscopic driver circuit, wherein the in-phase feedback signal includes a representation of the in-phase signal and a representation of the quadrature-phase signal.

18. The method of claim 17, comprising:
adjusting the in-phase feedback signal to limit a motion of the proof mass in a sense mode to substantially zero; and
determining a rate of rotation of the gyroscopic structure about a gyroscopic axis using the in-phase feedback signal.

19. A gyroscopic driver circuit configured to be coupled to a gyroscopic structure including a proof mass, the proof mass configured to vibrate in a first primary mode and a second primary mode, wherein in use the first primary mode is driven into resonance, wherein in use an in-phase signal is induced in the second primary mode in response to a rotation of the gyroscopic structure, the gyroscopic driver circuit comprising:
an in-phase leg, configured to carry the in-phase signal generated in the second primary mode of the gyroscopic structure;
a quadrature-phase leg, configured to carry a quadrature-phase signal generated in the second primary mode of the gyroscopic structure, wherein the quadrature-phase signal is in quadrature with the in-phase signal; and
in-phase feedback circuitry, configured to:
generate an in-phase feedback signal, wherein the in-phase feedback signal includes a representation of the signal on the in-phase leg and a representation of the signal on the quadrature-phase leg.

20. The gyroscopic driver circuit of claim 19, wherein the in-phase feedback circuitry is configured to generate the in-phase feedback signal so as to increase a measurement bandwidth of the gyroscopic structure.
